(19) United States
(12) Patent Application Publication
(10) Pub. No.: US 2024/0336523 A1
(43) Pub. Date: Oct. 10, 2024

(54) CONCRETE WITH VOLCANIC PUMICE

(71) Applicant: KING FAISAL UNIVERSITY, AL-AHSA (SA)

(72) Inventors: KAFFAYATULLAH KHAN, AL-AHSA (SA); MUHAMMAD NASIR AMIN, AL-AHSA (SA); NAVEED AHMAD, AL-AHSA (SA); MOHAMMED IBRAHIM, AL-AHSA (SA)

(21) Appl. No.: 18/132,250

(22) Filed: Apr. 7, 2023

(51) Int. Cl. C04B 14/16; C04B 28/04; C04B 40/00

(52) U.S. Cl. CPC C04B 14/16; C04B 28/04; C04B 40/0032; C04B 2103/32

(57) ABSTRACT

A concrete with natural volcanic pumice and a method of manufacturing a concrete with natural volcanic pumice are presented. The concrete with volcanic pumice replaces between 10%-20% of ordinary Portland cement present in conventional cement with ground natural volcanic pumice. The ground natural volcanic pumice is sourced from the Chagai magmatic arc and has a particularly large percentage of aluminosiliceous content. The concrete with natural volcanic pumice has improved compressive strength and water resistance.

### BACKGROUND

### 1. Field

The disclosure of the present patent application relates to concrete and, particularly, to a concrete composition including natural volcanic pumice.

### 2. Description of the Related Art

As the global community imposes stricter requirements for reducing greenhouse gas emissions, building material research has focused on developing low-carbon footprint materials. Concrete is the most popular, essential, and widely consumed man-made material due to its strength, longevity and affordability. In the built environment, cement contributes significantly to embodied carbon, contributing around 7% to the total global anthropogenic CO₂ emissions. In order to mitigate the impacts of global warming and climate change, reducing the CO₂ footprint in the cement industry is imperative.

One possible approach to significantly reduce the embodied carbon content of mortar and concrete is partially substituting cement with naturally available materials and industrial byproducts. Natural pozzolans, available in abundant quantities around the world, could be a viable substitute for cement in green concrete development. However, natural pozzolan from different sources varies significantly in chemical and physical properties.

Thus, a concrete with volcanic pumice solving the aforementioned problems is desired.

### SUMMARY

The concrete with volcanic pumice includes ground natural volcanic pumice (NVP). The NVP can replace about 10%-20% of the ordinary Portland cement (OPC) used in making concrete. The NVP is sourced from the Chagai magmatic are and has a particularly large percentage of aluminosiliceous content. The use of the NVP to replace a portion of the OPC provides a concrete with improved compressive strength and water resistance. The concrete with volcanic pumice may also include water, equal amounts of 10 mm and 20 mm coarse aggregate, fine aggregate, and a super plasticizer.

In an embodiment, a method of making a concrete comprises replacing about 10% to about 20% of the OPC with ground NVP and mixing the resulting concrete mixture with water to form concrete. This method may include the use of equal amounts of 10 mm and 20 mm coarse aggregate, which may be mixed with a fine aggregate and optionally a super plasticizer. The resulting concrete may have improved compressive strength and water resistance.

These and other features of the present subject matter will become readily apparent upon further review of the following specification.

### BRIEF DESCRIPTION OF THE DRAWINGS

FIG. 1 depicts a X-ray diffraction spectrum of natural volcanic pumice obtained from the Chagai magmatic arc in Pakistan.

FIG. 2 depicts a graph of the particle size distribution of ground natural volcanic pumice obtained from the Chagai magmatic arc in Pakistan.

FIG. 3 depicts a scanning electron micrograph of ground natural volcanic pumice obtained from the Chagai magmatic are in Pakistan.

Similar reference characters denote corresponding features consistently throughout the attached drawings.

### DETAILED DESCRIPTION OF THE PREFERRED EMBODIMENTS

The following definitions are provided for the purpose of understanding the present subject matter and for construing the appended patent claims.

### Definitions

It should be understood that the drawings described above or below are for illustration purposes only. The drawings are not necessarily to scale, with emphasis generally being placed upon illustrating the principles of the present teachings. The drawings are not intended to limit the scope of the present teachings in any way.

Throughout the application, where compositions are described as having, including, or comprising specific components, or where processes are described as having, including, or comprising specific process steps, it is contemplated that compositions of the present teachings can also consist essentially of, or consist of, the recited components, and that the processes of the present teachings can also consist essentially of, or consist of, the recited process steps.

It is noted that, as used in this specification and the appended claims, the singular forms “a”, “an”, and “the” include plural references unless the context clearly dictates otherwise.

In the application, where an element or component is said to be included in and/or selected from a list of recited elements or components, it should be understood that the element or component can be any one of the recited elements or components, or the element or component can be selected from a group consisting of two or more of the recited elements or components. Further, it should be understood that elements and/or features of a composition or a method described herein can be combined in a variety of ways without departing from the spirit and scope of the present teachings, whether explicit or implicit herein.

The use of the terms “include,” “includes”, “including,” “have,” “has,” or “having” should be generally understood as open-ended and non-limiting unless specifically stated otherwise.

The use of the singular herein includes the plural (and vice versa) unless specifically stated otherwise. In addition, where the use of the term “about” is before a quantitative value, the present teachings also include the specific quantitative value itself, unless specifically stated otherwise. As used herein, the term “about” refers to a ±10% variation from the nominal value unless otherwise indicated or inferred.

The term “optional” or “optionally” means that the subsequently described event or circumstance may or may not occur, and that the description includes instances where said event or circumstance occurs and instances in which it does not.

Unless defined otherwise, all technical and scientific terms used herein have the same meaning as commonly understood to one of ordinary skill in the art to which the presently described subject matter pertains.

Where a range of values is provided, for example, concentration ranges, percentage ranges, or ratio ranges, it is understood that each intervening value, to the tenth of the unit of the lower limit, unless the context clearly dictates otherwise, between the upper and lower limit of that range and any other stated or intervening value in that stated range, is encompassed within the described subject matter. The upper and lower limits of these smaller ranges may independently be included in the smaller ranges, and such embodiments are also encompassed within the described subject matter, subject to any specifically excluded limit in the stated range. Where the stated range includes one or both of the limits, ranges excluding either or both of those included limits are also included in the described subject matter.

Throughout the application, descriptions of various embodiments use “comprising” language. However, it will be understood by one of skill in the art, that in some specific instances, an embodiment can alternatively be described using the language “consisting essentially of” or “consisting of”.

For purposes of better understanding the present teachings and in no way limiting the scope of the teachings, unless otherwise indicated, all numbers expressing quantities, percentages or proportions, and other numerical values used in the specification and claims, are to be understood as being modified in all instances by the term “about”. Accordingly, unless indicated to the contrary, the numerical parameters set forth in the following specification and attached claims are approximations that may vary depending upon the desired properties sought to be obtained. At the very least, each numerical parameter should at least be construed in light of the number of reported significant digits and by applying ordinary rounding techniques.

As used herein, the term “superplasticizer” refers to a plasticizer for use when making high strength concrete that allows reduction in water content by 30% or more. Examples of superplasticizers include but are not limited to cross-linked melamine or naphthalene-sulfonates, such as sulfonated naphthalene formaldehyde condensate, sulfonated melamine formaldehyde condensate, and the like; acetone formaldehyde condensate; polycarboxylate ethers; and the like.

As used herein, the term “coarse aggregate” may refer to an aggregate having an average particle size of between 10 mm-20 mm, or a average particle size of 10 mm (10 mm coarse aggregate), or an average particle size of 20 mm (20 mm coarse aggregate).

As used herein, the term “fine aggregate” may refer to an aggregate that will pass through a No. 4 Sieve but is retained on a No. 200 sieve.

The concrete with volcanic pumice includes ground natural volcanic pumice (NVP) and ordinary Portland cement (OPC). In an embodiment, a density of the NVP can be about 10% to about 25% of the density of the OPC present in the concrete with volcanic pumice according to the present teachings. In a particular embodiment, the density of the NVP is about 11%, about 18%, or about 25% the density of the OPC. The NVP can be sourced from the

Chagai magmatic arc and has a particularly large percentage of aluminosiliceous content. The concrete with volcanic pumice may also include water, equal amounts of 10 mm and 20 mm coarse aggregate, fine aggregate, and a super plasticizer.

In an embodiment, the NVP replaces about 10%-20% of ordinary Portland cement (OPC) present in conventional concrete. The use of the NVP to replace a portion of the OPC provides a concrete with improved compressive strength and water resistance. In some embodiments, the concrete with volcanic pumice may include replacing 10%, 11%, 12%, 13%, 14%, 15%, 16%, 17%, 18%, 19%, or 20% of the OPC (by weight) in a particular concrete mixture with NVP.

In some embodiments, the NVP used may be NVP gathered from the Chagai magmatic arc, located in the north-western region of Balochistan, Pakistan. This NVP may be particularly desirable for concrete applications due to the increased amounts of SiO₂ and Al₂O₃ when compared to other sources of natural volcanic pumice. Both SiO₂ and Al₂O₃ may play an important role in the formation of phases, contributing to the strength of the resulting concrete. Generally, the use of NVP is understood to contribute to the later age strength of concrete but to show lesser strength at earlier ages (due in part to the low reactivity of the pozzolans found in the NVP). The use of NVP with increased amounts of SiO₂ and Al₂O₃, such as NVP sourced from the Chagai magmatic arc, provides improved strength both at the early and later ages.

The NVP can be ground prior to use in a cement mixture. The grinding may be accomplished by any method known in the art, including the use of roller mills, high pressure suspension grinding mills, ultrafine grinding mills, or rotary ball mills. In some embodiments, the pumice may be ground in a rotary ball mill. The average particle size of the ground pumice may be determined by the type of grinder and the duration of grinding. In some embodiments, the NVP may be ground until it passes through a 45 μm sieve. The use of particularly fine ground NVP may be desirable to increase the surface areas of the pozzolans dispersed throughout the cement, thereby contributing further to both strength and durability of the resulting concrete.

The concrete with volcanic pumice may be cured by any curing technique generally used in the art for curing conrete for structural applications in the constructions of buildings, bridges, roads, or the like.

In some embodiments, the concrete with volcanic pumice may be used to form cement with a water to cement (W/C) ratio between 0.3-0.6, including a W/C ratio of 0.3, 0.35, 0.4, 0.45, 0.5, 0.55, or 0.6. In particular embodiments, the W/C ratio may range from about 0.40 to about 0.45. For example, the W/C ratio may be about 0.4 or about 0.45.

In some embodiments. the concrete with volcanic pumice may include only OPC and ground NVP, or only OPC, ground NVP, and a superplasticizer.

In some embodiments, the unit weight of the concrete created using the concrete with volcanic pumice may be 2260 kg/m³ (W/C 0.45) or 2340 kg/m³ (W/C 0.40).

In an embodiment, a method of making the concrete comprising mixing OPC with the ground NVP and mixing the resulting concrete mixture with water to form concrete. In an embodiment, the method can further include adding coarse aggregate, fine aggregate, and optionally a super plasticizer to the mixture. The resulting concrete may have improved compressive strength and water resistance.

In an embodiment, the coarse aggregate may be selected from 10 mm aggregate, 20 mm aggregate, and a mixture of 10 mm and 20 mm coarse aggregate. In a further embodiment the method includes mixing equal amounts of 10 mm coarse aggregate and 20 mm coarse aggregate with a quantity of fine aggregate.

In some embodiments, the method of making concrete with volcanic pumice may include replacing 10%, 11%, 12%, 13%, 14%, 15%, 16%, 17%, 18%, 19%, or 20% of the OPC (by weight) in a particular concrete mixture with ground NVP.

In some embodiments, the method of making concrete with volcanic pumice may include obtaining NVP gathered from the Chagai magmatic arc, located in the north-western region of Balochistan, Pakistan.

In some embodiments, the method of making concrete with volcanic pumice may include grinding the NVP prior to using it in the concrete mixture. The grinding may be accomplished by any method known in the art, including the use of roller mills, high pressure suspension grinding mills, ultrafine grinding mills, or rotary ball mills. In some embodiments, the pumice may be ground in a rotary ball mill. The average particle size of the ground pumice may be determined by the type of grinder and the duration of grinding. In some embodiments, the NVP may be ground until it passes through a 45 μm sieve. The use of particularly fine ground NVP may be desirable to increase the surface areas of the pozzolans dispersed throughout the cement, thereby contributing further to both strength and durability of the resulting concrete.

In some embodiments, the method of making concrete with volcanic pumice may include curing the concrete with volcanic pumice by any curing technique generally used in the art for curing concrete for structural applications in the construction of buildings, bridges, roads, or the like.

In some embodiments, the method of making concrete with volcanic pumice may include mixing a cement mixture with water using a water to cement (W/C) ratio of about 0.4 or about 0.45.

Pozzolanic reactivity of natural pozzolan may play a significant role in achieving favorable properties when NVP is partially substituted for OPC in concrete. The quality and quantity of formation of secondary calcium silicate hydrate (C—S—H) upon hydration of natural pozzolan based cementitious binder predominantly defines the strength and durability of concrete. Amorphous aluminosiliceous content in natural pozzolan may play a critical role in the formation of C—S—H gel.

Natural deposits of volcanic pumice occur in the western part of the Chagai magmatic arc, located in the north-western part of Balochistan, Pakistan. This region is known as Koh-e-Sultan volcano, which covers an area of 770 km² and is mainly composed of andesitic-dacitic lava flows and pyroclastic sediments, including agglomerates, tuffs, pumices, volcanic conglomerates, and breccia. Therefore, this natural material can partially replace OPC in making durable and sustainable concrete. The resulting concrete has excellent mechanical properties and durability. The replacement of OPC with 15% powdered natural volcanic pumice resulted in excellent compressive strength and durability. Considering the results obtained, the concrete developed can be potentially used in structural applications.

The concrete with volcanic pumice may be better understood in view of the following examples.

### EXAMPLE 1

### Physical and Chemical Characteristics of NVP

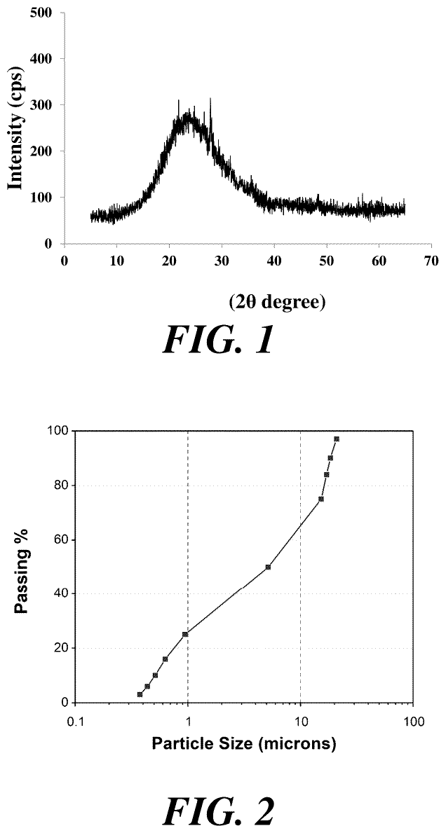

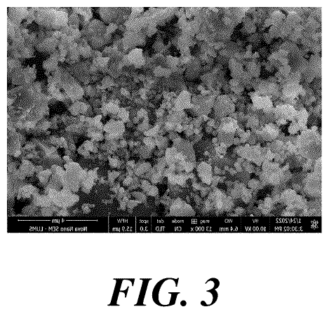

Natrual volcanic pumice (NVP) collected from the Chagai magmatic arc in the north-western region of Balochistan, Pakistan was assessed using X-ray diffraction analysis and other routine techniques known in the art to determine its physical properties and chemical compostion. The results are reported in FIG. 1 and Table 1.

TABLE 1
Physical and Chemical Properties of NVP
Physical properties

| | |
|---|---|
| BET surface area (m²/g) | 9.629 |
| d₁₀ (μm) | 0.460 |
| d₅₀ (μm) | 1.707 |
| d₉₀ (μm) | 18.53 |

Chemical composition (oxides, % by weight)

| | |
|---|---|
| SiO₂ | 74.60 |
| Al₂O₃ | 16.15 |
| Fe₂O₃ | 3.13 |
| CaO | 1.01 |
| MgO | 0.18 |
| Na₂O | 0.28 |
| K₂O | 2.01 |
| SO₃ | 0.35 |
| MnO | 0.18 |
| TiO₂ | 0.09 |
| LOI** | 2.02 |

### EXAMPLE 2

### Preparation and Testing of Test Mixes

The NVP of Example 1 was ground and four different mixtures of concrete were prepared for testing. The details of the mixtures may be found in Table 3.

A rotary ball mill operating at 15 rpm for 8 hours was used to grind the NVP. The resulting particle size distribution of ground NVP was analyzed by laser diffraction using a Microtrac S3500 and the results are illustrated in FIG. 2. The amount of natural possolans retained on the 45 μm sieve was 34%, according to ASTM C618-22. Particle Size analysis results confirmed 100% of the ground natural pozolans passed through the 45 μm (no. 325) sieve and met the ASTM standards for natural pozzolans to be used as cement substitutes.

As referred to in Table 3 below, the fine aggregate is an aggregate that will pass through a No. 4 Sieve but is retained on a No. 200 sieve. The resulting fine aggregate, or “sand”, has a particle distribution as shown in Table 2. The super plasticizer used was “Master Rheobuild 1100”.

TABLE 2
Particle Size Distribution of Fine Aggregate

| | Sieve | | | | |
|---|---|---|---|---|---|
| Sieve | Sizes | Wt. Retained | Wt. Retained | Cumulative % | Cumulative |
| No | (mm) | (g) | (%) | Retained | % Passing |
| #4 | 4.760 | 0 | 0 | 0 | 100 |
| #8 | 2.380 | 21 | 4 | 4 | 96 |
| #16 | 1.190 | 101.5 | 20 | 25 | 75 |
| #30 | 0.595 | 131.3 | 26 | 51 | 49 |
| #50 | 0.297 | 158 | 32 | 82 | 18 |
| #100 | 0.149 | 83.5 | 17 | 99 | 1 |
| Pan | — | 4 | 1 | — | — |

TABLE 3
Concrete Test Mixtures (W/C: 0.45 & W/C: 0.4)

| | | | Water | | Coarse | Coarse | | Super plasticizer | |
|---|---|---|---|---|---|---|---|---|---|
| | | | (kg/m³) | | Agg. | Agg. | Fine | (% of OPC by wt.) | |
| Mix | OPC | NVP | W/C: | W/C: | (10 mm) | (20 mm) | Agg. | W/C: | W/C: |
| ID | (kg/m³) | (kg/m³) | 0.45 | 0.4 | (kg/m³) | (kg/m³) | (kg/m³) | 0.45 | 0.4 |
| M1 | 400 | 0 | 180 | 160 | 500 | 500 | 600 | 0.80 | 1.00 |
| M2 | 360 | 40 | 180 | 160 | 500 | 500 | 600 | 0.85 | 1.10 |
| M3 | 340 | 60 | 180 | 160 | 500 | 500 | 600 | 0.90 | 1.15 |
| M4 | 320 | 80 | 180 | 160 | 500 | 500 | 600 | 0.90 | 1.20 |

These mixtures were then tested to determine compressive strength of the resulting conrete with repsect to aging as well as water absorption and apparent porosity at 56 days. The results are shown in Tables 3 and 4.

TABLE 4
Evolution of Compressive Strength with Respect to Aging and W/C

| | Compressive Strength (MPa) | | | | | | | |
|---|---|---|---|---|---|---|---|---|
| | W/C: 0.45 | | | | W/C: 0.4 | | | |
| Mix ID | 7 Days | 28 Days | 56 Days | 91 Days | 7 Days | 28 Days | 56 Days | 91 Days |
| M1 | 13.5 | 15.5 | 23.3 | 24.5 | 24.0 | 34.1 | 37.2 | 38.1 |
| C100% | | | | | | | | |
| M2 | 14.2 | 18.4 | 24.6 | 25.0 | 24.2 | 36.4 | 40.1 | 41.0 |
| C90% | | | | | | | | |
| NVP10% | | | | | | | | |
| M3 | 17.7 | 24.9 | 27.7 | 28.3 | 29.3 | 40.1 | 42.7 | 43.4 |
| C85% | | | | | | | | |
| NVP15% | | | | | | | | |
| M4 | 16.6 | 23.6 | 24.9 | 25.6 | 30.1 | 38.2 | 40.3 | 41.6 |
| C80% | | | | | | | | |
| NVP20% | | | | | | | | |

TABLE 5
Water Absorption and Apparent Porosity
of Concrete Mixes at 56 Days

| | W/C: 0.45 | | W/C: 0.4 | |
|---|---|---|---|---|
| | Water | Apparent | Water | Apparent |
| | Absorp- | Porosity | Absorp- | Porosity |
| Mix ID | tion % | % | tion % | % |
| M1 (C100%) | 3.20 | 5.50 | 1.77 | 3.99 |
| M2 (C90% NVP10%) | 2.30 | 3.40 | 0.86 | 2.25 |
| M3 (C85% NVP15%) | 2.0 | 3.0 | 0.75 | 1.64 |
| M4 (C80% NVP20%) | 1.60 | 2.30 | 0.68 | 1.52 |

It is to be understood that the concrete with volcanic pumice is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

1. A concrete composition comprising ordinary Portland cement, ground natural volcanic pumice, coarse aggregate, and fine aggregate, wherein the ground natural volcanic pumice is from the Chagai magmatic arc, has a SiO₂ content of about 74.6%, and has a particle size that passes through a 45 μm sieve.

2. (canceled)

3. The concrete composition of claim 1, further comprising a superplasticizer.

4. The concrete composition of claim 1, wherein the natural volcanic pumice has a density that ranges from about 10% to about 25% of the density of the ordinary Portland cement.

5. The concrete composition of claim 1, wherein the concrete comprises 500 kg/m³ 10 mm coarse aggregate, 500 kg/m³ 20 mm coarse aggregate, and 600 kg/m³ fine aggregate.

6. The concrete composition of claim 1, wherein the concrete comprises between 320 to 360 kg/m³ ordinary Portland cement.

7. The concrete composition of claim 1, wherein the concrete comprises between 40 to 80 kg/m³ ground natural volcanic pumice.

8. The concrete composition of claim 1, further comprising water at a W/C ratio of 0.4.

9. The concrete composition of claim 1, further comprising water at a W/C ratio of 0.45.

10. A method of making concrete comprising mixing ground natural volcanic pumice from the Chagai magmatic arc having a SiO₂ content of about 74.6% and a particle size that passes through a 45 μm sieve, ordinary Portland cement, coarse aggregate, fine aggregate, and a superplasticizer with water to form a mixture and curing the mixture to form concrete.

11. (canceled)

12. The method of claim 10, wherein the natural volcanic pumice replaces between 10%-20% of the ordinary Portland cement by weight.

13. The method of claim 10, wherein 500 kg/m³ of a 10 mm coarse aggregate, 500 kg/m³ of a 20 mm coarse aggregate, and 600 kg/m³ of a fine aggregate are present in the mixture.

14. The method of claim 10, wherein between 320 to 360 kg/m³ of the ordinary Portland cement is present in the mixture.

15. The method of claim 10, wherein between 40 to 80 kg/m³ of the ground natural volcanic pumice is present in the mixture.

16. The method of claim 10, further comprising mixing the water at a W/C ratio of 0.4.

17. The method of claim 10, further comprising mixing the water at a W/C ratio of 0.45.
